(19) United States
(12) Patent Application Publication
(10) Pub. No.: US 2022/0291367 A1
(43) Pub. Date: Sep. 15, 2022

(54) OBJECT DETECTION DEVICE AND MOVING BODY CONTROL DEVICE

(71) Applicant: AISIN CORPORATION, Kariya (JP)

(72) Inventors: Kosuke WAKITA, Kariya-shi (JP); Ippei SUGAE, Kariya-shi (JP); Shingo FUJIMOTO, Kariya-shi (JP)

(73) Assignee: AISIN CORPORATION, Kariya (JP)

(21) Appl. No.: 17/683,451

(22) Filed: Mar. 1, 2022

(30) Foreign Application Priority Data
Mar. 15, 2021 (JP) 2021-041700

(51) Int. Cl. G01S 7/52; G01P 5/00; G01S 15/931; B60W 30/09

(52) U.S. Cl. CPC G01S 7/52004; G01P 5/00; G01S 15/931; B60W 30/09; G01S 2015/938; B60W 2554/80

(57) ABSTRACT

An object detection device that detects an object existing around a moving body moving on a road surface by transmitting and receiving ultrasonic waves, includes: a first acquisition unit configured to acquire reflection intensity information indicating an intensity of a reflected wave from the object; a first generation unit configured to generate object information indicating existence of a predetermined detection target when the reflected wave having an intensity exceeding a threshold value is received; an estimation unit configured to estimate a wind speed based on a road surface reflection intensity, which is an intensity of a reflected wave from the road surface; and a setting unit configured to change the threshold value according to the wind speed.

### CROSS REFERENCE TO RELATED APPLICATIONS

This application is based on and claims priority under 35 U.S.C. § 119 to Japanese Patent Application 2021-041700, filed on Mar. 15, 2021, the entire content of which is incorporated herein by reference.

### TECHNICAL FIELD

This disclosure relates to an object detection device and a moving body control device.

### BACKGROUND DISCUSSION

In a vehicle control system or the like, a device for detecting an object existing around a vehicle by transmitting and receiving ultrasonic waves is used.

An example of the related art includes JP 2018-34653A.

In the object detection using the ultrasonic waves, a detection accuracy may decrease due to influence of wind blowing in a detection region.

A need thus exists for a device for detecting an object which is not susceptible to the drawback mentioned above.

### SUMMARY

An object detection device according to an aspect of this disclosure is an object detection device that detects an object existing around a moving body moving on a road surface by transmitting and receiving ultrasonic waves. The object detection device includes: a first acquisition unit configured to acquire reflection intensity information indicating an intensity of a reflected wave from the object; a first generation unit configured to generate object information indicating existence of a predetermined detection target when the reflected wave having an intensity exceeding a threshold value is received; an estimation unit configured to estimate a wind speed based on a road surface reflection intensity, which is an intensity of a reflected wave from the road surface; and a setting unit configured to change the threshold value according to the wind speed.

A moving body control device according to an aspect of this disclosure includes: the object detection device described above; and a control device configured to perform a process for controlling the moving body based on the object information output from the object detection device.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a top diagram showing an example of a configuration of a vehicle according to an embodiment;

FIG. 2 is a block diagram showing an example of a configuration of a vehicle control device according to the embodiment;

FIG. 3 is a block diagram showing an example of a functional configuration of an object detection device according to the embodiment;

FIG. 4 is a diagram showing an example of echo information when detecting a detection target according to the embodiment;

FIG. 5 is a diagram showing an example of a feature of a wind speed table according to the embodiment;

FIG. 6 is a diagram showing an example of a feature of a gain that weights a wind speed according to a vehicle speed in the embodiment;

FIG. 7 is a diagram showing an example of a feature of a threshold value table according to the embodiment;

FIG. 8 is a diagram showing an example of a threshold value margin according to the embodiment; and

FIG. 9 is a flowchart showing an example of a process in the object detection device according to the embodiment.

### DETAILED DESCRIPTION

Hereinafter, embodiments of this disclosure will be described with reference to drawings. Configurations of the embodiments described below and functions and effects provided by the configurations are merely examples, and this disclosure is not limited to the following description.

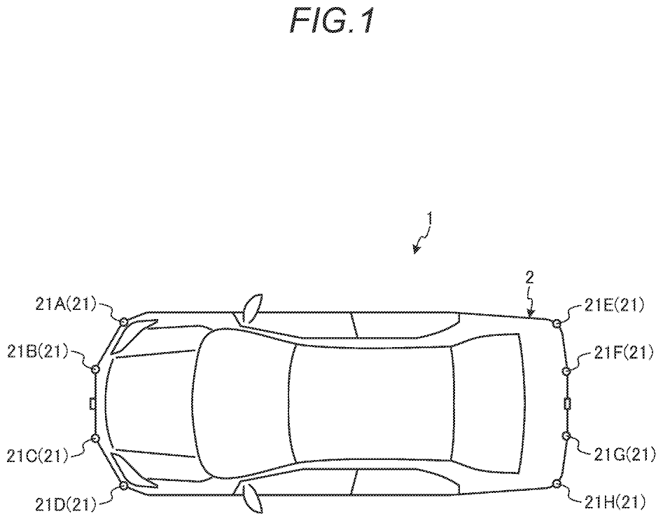

FIG. 1 is a top diagram showing an example of a configuration of a vehicle 1 according to an embodiment. The vehicle 1 is an example of a moving body on which an object detection device according to the present embodiment is mounted. The object detection device according to the present embodiment is a device that detects an object existing around the vehicle 1 based on TOF, doppler shift information, and the like acquired by transmitting an ultrasonic wave from the vehicle 1 and receiving a reflected wave from the object.

The object detection device according to the present embodiment includes a plurality of transmission and reception units 21A to 21H (hereinafter, abbreviated as transmission and reception units 21 when it is not necessary to distinguish between the plurality of transmission and reception units 21A to 21H). The transmission and reception units 21 are provided on a vehicle body 2 as an exterior of the vehicle 1, transmit an ultrasonic wave (a transmitted wave) to the outside of the vehicle body 2, and receive a reflected wave from an object existing outside the vehicle body 2. In the example shown in FIG. 1, four transmission and reception units 21A to 21D are arranged at a front end of the vehicle body 2, and four transmission and reception units 21E to 21H are arranged at a rear end. The number and arranged positions of the transmission and reception units 21 are not limited to the above example.

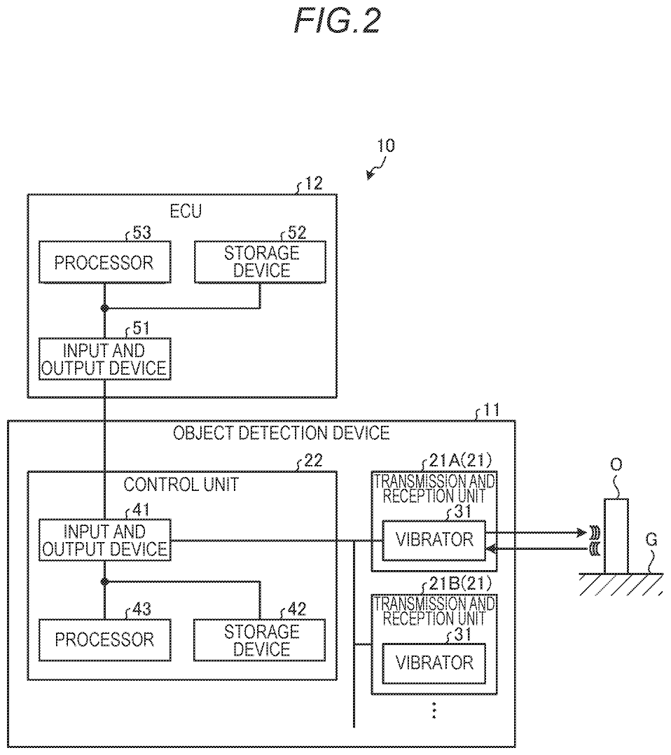

FIG. 2 is a block diagram showing an example of a configuration of a vehicle control device 10 according to the embodiment. The vehicle control device 10 (an example of a moving body control device) includes an object detection device 11 and an ECU 12. The vehicle control device 10 performs a process for controlling the vehicle 1 based on information output from the object detection device 11.

The object detection device 11 includes a plurality of the transmission and reception units 21 and a control unit 22. Each of the transmission and reception units 21 includes a vibrator 31 configured using a piezoelectric element or the like, an amplifier, and the like, and achieves the transmission and reception of the ultrasonic waves by vibration of the vibrator 31. Specifically, each of the transmission and reception units 21 transmits the ultrasonic wave generated in response to the vibration of the vibrator 31 as the transmitted wave, and detects the vibration of the vibrator 31 caused by the reflected wave obtained by reflecting the transmitted wave by the object. The object includes a detection target O from which the vehicle 1 should avoid contact, and a road surface G on which the vehicle 1 travels. The vibration of the vibrator 31 is converted into an electric signal, and echo information indicating a change over time in an intensity (an amplitude) of the reflected wave from the object can be acquired based on the electric signal. The TOF or the like corresponding to a distance from the transmission and reception unit 21 (the vehicle body 2) to the object can be acquired based on the echo information.

The echo information may be generated based on data acquired by one of the transmission and reception units 21, and may be generated based on a plurality of pieces of data acquired by the plurality of transmission and reception units 21. For example, the echo information on an object existing in front of the vehicle body 2 may be generated based on two or more pieces of data (for example, average values) acquired by two or more of the four transmission and reception units 21A to 21D arranged at front side of the vehicle body 2 (see FIG. 1). Similarly, the echo information on an object existing behind the vehicle body 2 may be generated based on two or more pieces of data acquired by two or more of the four transmission and reception units 21E to 21H arranged at rear side of behind the vehicle body 2 (see FIG. 1).

In the example shown in FIG. 2, a configuration in which both the transmission of the transmitted wave and the reception of the reflected wave are performed by using the single vibrator 31 is illustrated, but the configuration of the transmission and reception unit 21 is not limited to this. For example, a transmission side and a reception side may be separated from each other, such as a configuration in which a vibrator for transmitting a transmitted wave and a vibrator for receiving a reflected wave are individually provided.

The control unit 22 includes an input and output device 41, a storage device 42, and a processor 43. The input and output device 41 is an interface device for implementing transmission and reception of information between the control unit 22 and an external mechanism (the transmission and reception units 21, the ECU 12, and the like). The storage device 42 includes a main storage device such as a read only memory (ROM) and a random access memory (RAM), and an auxiliary storage device such as a hard disk drive (HDD) and a solid state drive (SSD). The processor 43 is an integrated circuit that executes various processes for achieving a function of the control unit 22, and includes, for example, a central processing unit (CPU) that operates according to a program, an application specific integrated circuit (ASIC) designed for a specific application, and the like. The processor 43 executes various arithmetic processes and control processes by reading and executing programs stored in the storage device 42.

The ECU 12 is a unit that performs various processes for controlling the vehicle 1 based on various information acquired from the object detection device 11 or the like. The ECU 12 includes an input and output device 51, a storage device 52, and a processor 53. The input and output device 51 is an interface device for implementing transmission and reception of information between the ECU 12 and an external mechanism (the object detection device 11, a drive mechanism, a brake mechanism, a steering mechanism, a transmission mechanism, an in-vehicle display, a speaker, and the like). The storage device 52 includes a main storage device such as a ROM and a RAM, and an auxiliary storage device such as an HDD and an SSD. The processor 53 is an integrated circuit that executes various processes for achieving a function of the ECU 12, and includes, for example, a CPU and an ASIC. The processor 53 executes various arithmetic processes and control processes by reading programs stored in the storage device 52.

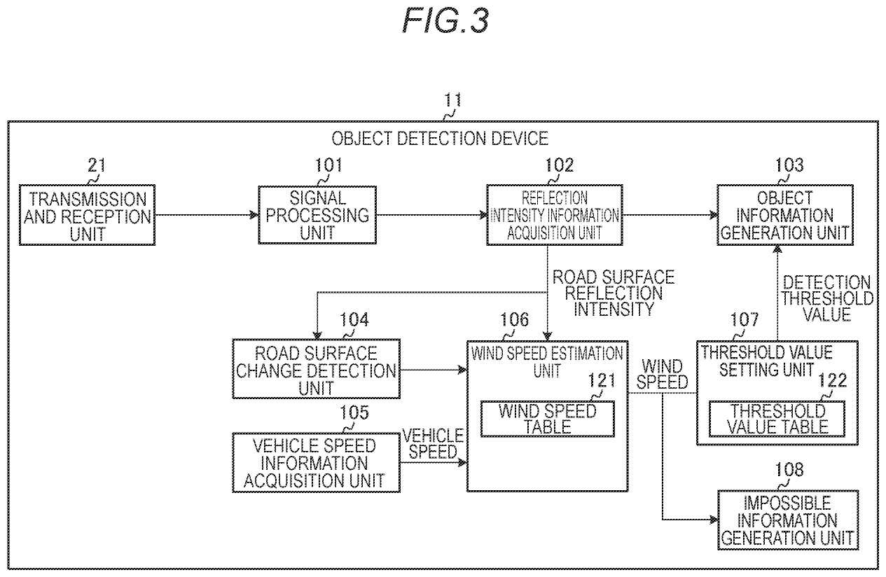

FIG. 3 is a block diagram showing an example of a functional configuration of the object detection device 11 according to the embodiment. The object detection device 11 according to the present embodiment includes a signal processing unit 101, a reflection intensity information acquisition unit 102 (first acquisition unit), an object information generation unit 103 (first generation unit), a road surface change detection unit 104 (detection unit), a vehicle speed information acquisition unit 105 (second acquisition unit), a wind speed estimation unit 106 (estimation unit), a threshold value setting unit 107 (setting unit), and an impossible information generation unit 108 (second generation unit). These functional components 101 to 108 are implemented by cooperation of hardware components of the object detection device 11 illustrated in FIG. 2 and software components such as firmware and programs.

The signal processing unit 101 processes the data acquired by the transmission and reception units 21 and generates various information. The signal processing unit 101 performs, for example, an amplification process, a filter process, an envelope process, and the like on the electric signal corresponding to the vibration of the vibrator 31, and generates the echo information indicating the change over time in the intensities (the amplitudes) of the reflected waves obtained by reflecting the transmitted waves transmitted by the transmission and reception units 21 by the object. The TOF corresponding to the object existing around the vehicle 1 can be detected, and the distance from the vehicle body 2 to the object can be calculated, based on the echo information.

The reflection intensity information acquisition unit 102 acquires reflection intensity information indicating the intensity of the reflected wave from the object based on the echo information or the like generated by the signal processing unit 101. The reflection intensity information includes an intensity of a reflected wave from a predetermined detection target O and a road surface reflection intensity which is an intensity of a reflected wave from the road surface G. The predetermined detection target O is an object from which the vehicle 1 should avoid contact, and can be, for example, another vehicle, a structure, a pedestrian, and the like. The road surface reflection intensity is the intensity of the reflected wave having the TOF corresponding to the distance from the transmission and reception unit 21 to the road surface G. The distance from the transmission and reception unit 21 to the road surface G may be a known value.

The object information generation unit 103 generates object information indicating existence of the detection target O when a reflected wave having an intensity exceeding a predetermined detection threshold value is received. The detection threshold value is a threshold value set for specifying (extracting) the reflected wave from the detection target O from all the reflected waves received by the transmission and reception units 21. That is, the detection threshold value is set to exclude the reflected wave from an object (for example, road surface G) other than the detection target O from all the reflected waves received by the transmission and reception units 21. Generally, the higher the detection threshold value, the lower a sensitivity for detecting the detection target O (the shorter a detectable distance).

The road surface change detection unit 104 detects a change in a state of the road surface G based on a change in the road surface reflection intensity included in the reflection intensity information. The change in the state of the road surface G can be, for example, a change in a material, an amount of water, a temperature, and the like. Such a change causes a change in a frictional resistance of the road surface G. The road surface reflection intensity changes in response to such a change in the state of the road surface G. For example, when the road surface reflection intensity changes so as to decrease the frictional resistance (for example, when the material of the road surface G changes from asphalt to concrete), the road surface reflection intensity decreases. The change in the state of the road surface G can be detected by monitoring such a change in the road surface reflection intensity.

For example, the road surface change detection unit 104 may determine that a state of a road surface changes when a difference between an average value of a plurality of road surface reflection intensities acquired at an initial stage from a road surface reflection intensity group including the plurality of road surface reflection intensities acquired by transmitting and receiving the ultrasonic waves multiple times in succession and an average value of a plurality of the road surface reflection intensities acquired at a final stage from the road surface reflection intensity group is equal to or greater than a threshold value. The plurality of road surface reflection intensities acquired at the initial stage can be, for example, 20 road surface reflection intensities acquired at the initial stage from the road surface reflection intensity group including 100 road surface reflection intensities. Similarly, the plurality of road surface reflection intensities acquired at the final stage can be, for example, 20 road surface reflection intensities acquired at the final stage from the road surface reflection intensity group including 100 road surface reflection intensities. The numbers “100” and “20” are merely examples and are not limited to this.

The vehicle speed information acquisition unit 105 acquires speed information indicating a moving speed (vehicle speed) of the vehicle 1. The speed information can be acquired from, for example, the ECU 12 or the like that controls traveling of the vehicle 1.

The wind speed estimation unit 106 estimates a wind speed based on the road surface reflection intensity included in the reflection intensity information. The wind speed estimation unit 106 may estimate that the larger a degree of variation in the plurality of road surface reflection intensities acquired by transmitting and receiving the ultrasonic waves multiple times, the higher the wind speed. The ultrasonic waves transmitted and received by the transmission and reception units 21 are affected by wind (distortion of air which is a medium of the ultrasonic waves) blowing in a detection region (periphery of the vehicle 1), and the influence increases as the wind speed increases. Therefore, it can be determined that the larger the degree of variation in the road surface reflection intensities, the higher the wind speed. The wind speed estimation unit 106 may estimate the wind speed by using a wind speed table 121 in which the degree of variation in the road surface reflection intensities is associated with the wind speed. The wind speed table 121 may be stored in an appropriate storage device (for example, storage devices 42, 52) in advance, for example.

In addition, the wind speed estimation unit 106 may estimate the wind speed based on the vehicle speed in addition to the road surface reflection intensities. In this case, a process (for example, a gain process) in which the wind speed increases as the vehicle speed increases may be performed.

In addition, the wind speed estimation unit 106 may discard the road surface reflection intensities corresponding to the road surface G when the change in the state of the road surface G is detected. Therefore, it is possible to reduce a possibility that a variation in the road surface reflection intensities caused by the change in the state of the road surface G and a variation in the road surface reflection intensities due to the influence of the wind are confused with each other, and it is possible to improve an estimation accuracy of the wind speed.

The threshold value setting unit 107 changes the detection threshold value according to the wind speed estimated by the wind speed estimation unit 106. The threshold value setting unit 107 increases the detection threshold value according to the increase in the wind speed. Accordingly, when the influence of the wind is relatively large, a detection sensitivity of the detection target O can be decreased and an erroneous detection can be suppressed. In addition, the threshold value setting unit 107 may decrease the detection threshold value according to the decrease in the wind speed. Accordingly, when the influence of the wind is relatively small, the detection sensitivity can be increased. The threshold value estimation unit 107 may set the detection threshold value by using a threshold value table 122 in which the wind speed is associated with the detection threshold value. The threshold value table 122 may be stored in the appropriate storage device (for example, storage devices 42, 52) in advance, for example.

The impossible information generation unit 108 generates impossible information indicating that the detection target O cannot be detected by transmitting and receiving the ultrasonic waves when the wind speed estimated by the wind speed estimation unit 106 exceeds a predetermined upper limit value. Therefore, when the influence of the wind is large and a sufficient detection accuracy cannot be obtained, the use of a detection result of the object detection device 11 can be stopped, and a possibility that a detection result with a low reliability is used for vehicle control or the like can be reduced.

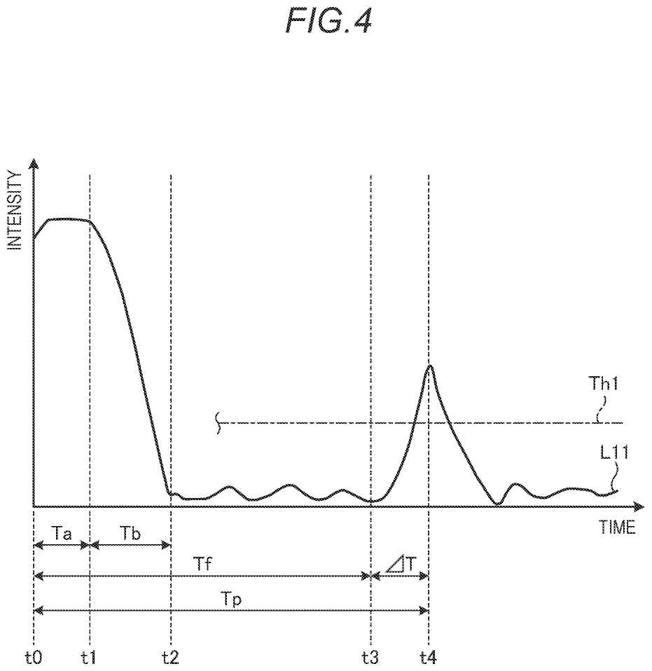

FIG. 4 is a diagram showing an example of echo information when detecting the detection target O according to the embodiment. FIG. 4 illustrates an envelope L11 as the echo information indicating the change over time in the intensity of the ultrasonic waves transmitted and received by the transmission and reception units 21. In a graph shown in FIG. 4, a horizontal axis corresponds to a time (the TOF), and a vertical axis corresponds to the intensity of the ultrasonic waves transmitted and received by the transmission and reception units 21.

The envelope L11 shows the change over time in the intensity indicating a magnitude of the vibration of the vibrator 31. It can be read from the envelope L11 that the vibrator 31 is driven from a timing t0 by a time Ta to vibrate, so that the transmission of the transmitted waves is completed at a timing t1, and then the vibration of the vibrator 31 due to inertia continues while being damped during a time Tb until a timing t2. Therefore, in the graph shown in FIG. 4, the time Tb corresponds to a so-called reverberation time.

The envelope L11 reaches a peak at which the magnitude of the vibration of the vibrator 31 becomes equal to or greater than a detection threshold value Th1 at a timing t4 when a time Tp elapses from the timing t0 at which the transmission of the transmitted waves is started. The detection threshold value Th1 is a value which is set to identify whether the vibration of the vibrator 31 is caused by the reception of the reflected wave from the detection target O (the other vehicle, the structure, the pedestrian, and the like), or whether the vibration is caused by the reception of the reflected wave from the object (for example, the road surface G) other than the detection target O. Here, the detection threshold value Th1 is shown as a constant value, but the detection threshold value Th1 according to the present embodiment is a variable value that changes depending on a situation (the wind speed, or the like). Therefore, a vibration having a peak equal to or greater than the detection threshold value Th1 can be regarded as being caused by the reception of the reflected waves from the detection target O.

In the envelope L11 of this example, it is shown that the vibration of the vibrator 31 is damped after the timing t4. Therefore, the timing t4 corresponds to a timing when the reception of the reflected wave from the detection target O is completed, that is, a timing when the transmitted wave last transmitted at the timing t1 returns as the reflected wave.

In addition, in the envelope L11, a timing t3 as a start point of the peak at the timing t4 corresponds to a timing when the reception of the reflected wave from the detection target O starts, that is, a timing when the transmitted wave first transmitted at the timing t0 returns as the reflected wave. Therefore, a time ΔT between the timing t3 and the timing t4 becomes equal to the time Ta as a transmission time of the transmitted wave.

Based on the above, in order to obtain a distance from a transmission and reception source of the ultrasonic waves to the detection target O using the TOF, it is necessary to obtain a time Tf between the timing t0 when the transmitted wave starts to be transmitted and the timing t3 when the reflected wave starts to be received. The time Tf can be obtained by subtracting the time ΔT equal to the time Ta as the transmission time of the transmitted wave from the time Tp as a difference between the timing t0 and the timing t4 when the intensity of the reflected wave exceeds the detection threshold value Th1 and reaches the peak.

The timing t0 when the transmitted wave starts to be transmitted can be easily specified as a timing when the object detection device 11 starts operating, and the time Ta as the transmission time of the transmitted wave is predetermined by a setting or the like. Therefore, the distance from the transmission and reception source to the detection target O can be obtained by specifying the timing t4 when the peak at which the intensity of the reflected wave is equal to or greater than the detection threshold value Th1 is reached. The object information generation unit 103 generates the object information on the detection target O by, for example, the above method.

An example of a method for estimating a wind speed by the wind speed estimation unit 106 will be described below. The wind speed estimation unit 106 according to the present embodiment estimates a wind speed by using the wind speed table 121 showing a correspondence relationship between a degree of variation in a road surface reflection intensity and a vehicle speed.

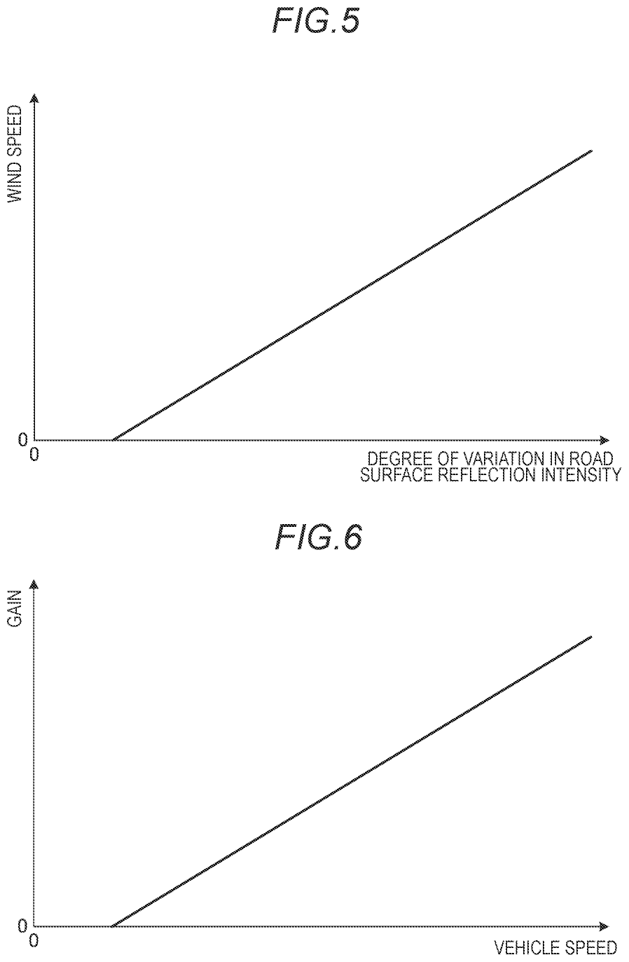

FIG. 5 is a diagram showing an example of a feature of the wind speed table 121 according to the embodiment. FIG. 5 illustrates a graph showing the correspondence relationship between the degree of variation in a plurality of road surface reflection intensities acquired by transmitting and receiving ultrasonic waves multiple times and the wind speed. The degree of variation can be, for example, a standard deviation or the like. As shown in FIG. 5, the wind speed table 121 according to the present embodiment estimates that the wind speed increases as the degree of variation in the road surface reflection intensities increases.

In addition, as described above, the wind speed estimation unit 106 according to the present embodiment estimates the wind speed in consideration of the vehicle speed. Basically, the wind speed estimation unit 106 estimates that the wind speed increases as the vehicle speed increases. A method for reflecting a vehicle speed in a wind speed is not particularly limited, but for example, there is a method for setting a gain that weights the wind speed estimated as described above according to a vehicle speed.

FIG. 6 is a diagram showing an example of a feature of the gain that weights the wind speed according to the vehicle speed in the embodiment. As shown in FIG. 6, the gain is set to increase as the vehicle speed increases. By using such a gain, the wind speed is estimated to be larger as the vehicle speed increases even if the degree of variation is the same. Such a gain may be included in the wind speed table 121 in advance, or may be calculated for each timing when the wind speed is estimated.

The threshold value setting unit 107 according to the present embodiment sets the detection threshold value Th1 using the threshold value table 122 in which the wind speed estimated as described above is associated with the detection threshold value Th1.

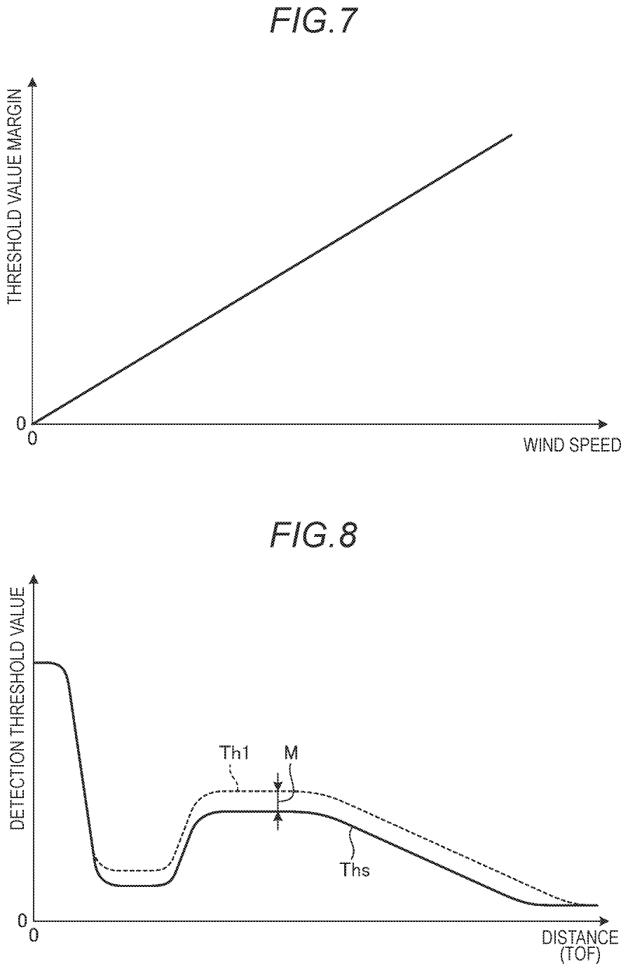

FIG. 7 is a diagram showing an example of a feature of the threshold value table 122 according to the embodiment. The threshold value table 122 illustrated here shows a relationship between the wind speed and a threshold value margin.

FIG. 8 is a diagram showing an example of a threshold value margin M according to the embodiment. FIG. 8 illustrates a reference detection threshold value Ths and the detection threshold value Th1 set according to the wind speed. The reference detection threshold value Ths is a preset detection threshold value, and can be, for example, a detection threshold value when the wind speed is 0. The reference detection threshold value Ths illustrated here changes according to the distance (TOF) from the transmission and reception unit 21 to the object, but a form of the reference detection threshold value Ths is not limited to this. The threshold value margin M is a value indicating a difference between the reference detection threshold value Ths and a final detection threshold value Th1, in other words, a change amount (increase amount) of the final detection threshold value Th1 from the reference detection threshold value Ths. As shown in FIG. 7, the threshold value table 122 according to the present embodiment sets the threshold value margin M to be larger as the wind speed increases.

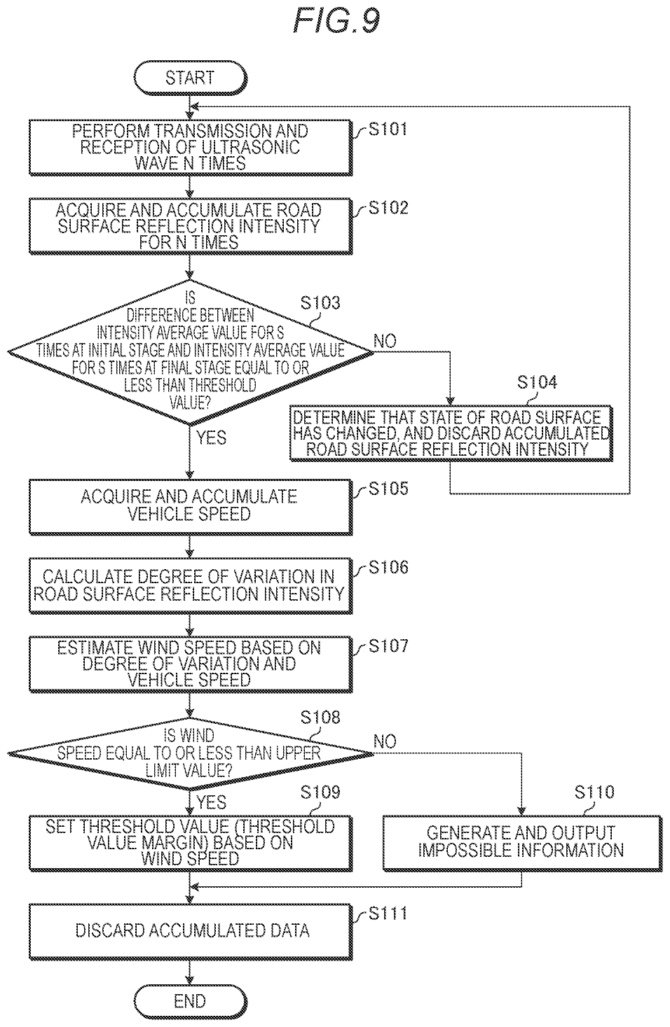

FIG. 9 is a flowchart showing an example of a process in the object detection device 11 according to the embodiment. When the transmission and reception of the ultrasonic waves is performed N times by the transmission and reception units 21 (S101), the reflection intensity information acquisition unit 102 acquires the road surface reflection intensities for N times, and accumulates the acquired road surface reflection intensities in the storage device (S102). N is preferably a value that can calculate the degree of variation (for example, the standard deviation) of the plurality of road surface reflection intensities with a sufficient accuracy, and can be a value of, for example, about 100.

Thereafter, the road surface change detection unit 104 determines whether a difference between an average value of road surface reflection intensities for S times acquired at an initial stage of the road surface reflection intensities for N times and an average value of road surface reflection intensities for the S times acquired at a final stage of the road surface reflection intensities for N times is equal to or less than a threshold value (S103). Here, a relationship of N>S may be satisfied, and specifically, for example, N=100, S=20, and the like. When the difference between the initial intensity average value and the final intensity average value is not equal to or less than the threshold value (S103: No), the road surface change detection unit 104 determines that the state of the road surface G has changed, the wind speed estimation unit 106 discards the accumulated the road surface reflection intensities for N times (S104), and the step S101 is executed again. On the other hand, when the difference between the initial intensity average value and the final intensity average value is equal to or less than the threshold value (S103: Yes), the vehicle speed information acquisition unit 105 acquires the vehicle speed (a moving speed of the vehicle 1) and accumulates the vehicle speed in the storage device (S105).

The wind speed estimation unit 106 calculates the degree of variation in the accumulated road surface reflection intensities for N times (S106), and estimates the wind speed using the wind speed table 121 or the like based on the calculated degree of variation and the accumulated vehicle speed (S107). The impossible information generation unit 108 determines whether the wind speed estimated by the wind speed estimation unit 106 is equal to or less than the upper limit value (S108). When the wind speed is equal to or less than the upper limit value (S108: Yes), the threshold value setting unit 107 sets a threshold value (threshold value margin) based on the estimated wind speed (S109), and after the data accumulated in the storage device is discarded (S111), this routine ends. On the other hand, when the wind speed is not equal to or less than the upper limit value (S108: No), the impossible information generation unit 108 generates the impossible information indicating that the detection target O cannot be detected by transmitting and receiving the ultrasonic waves, and outputs the impossible information to the ECU 12 or the like (S110). Then, after the data accumulated in the storage device is discarded (S111), this routine ends.

According to the above embodiment, it is possible to reduce the influence of the wind in the device that detects the object by using the ultrasonic waves.

A program for causing a computer (for example, the processor 43 of the control unit 22, the processor 53 of the ECU 12 or the like) to execute a process for achieving the various functions according to the above embodiment can be provided by being recorded as a file in an installable or executable format in a computer-readable recording medium such as a compact disc (CD)-ROM, a flexible disc (FD), a compact disc recordable (CD-R), or a digital versatile disk (DVD). In addition, the program may be provided or distributed via a network such as Internet.

An object detection device according to an aspect of this disclosure is an object detection device that detects an object existing around a moving body moving on a road surface by transmitting and receiving ultrasonic waves. The object detection device includes: a first acquisition unit configured to acquire reflection intensity information indicating an intensity of a reflected wave from the object; a first generation unit configured to generate object information indicating existence of a predetermined detection target when the reflected wave having an intensity exceeding a threshold value is received; an estimation unit configured to estimate a wind speed based on a road surface reflection intensity, which is an intensity of a reflected wave from the road surface; and a setting unit configured to change the threshold value according to the wind speed.

According to the above configuration, the threshold value for detecting the detection target can be adjusted so that influence of the wind speed is reduced according to the wind speed estimated based on the road surface reflection intensity. Therefore, the influence of the wind can be reduced.

In addition, the setting unit may increase the threshold value according to an increase in the wind speed.

Therefore, it is possible to reduce a possibility of an erroneous detection in a situation where the wind speed is high.

In addition, the estimation unit may estimate that the larger a degree of variation in a plurality of the road surface reflection intensities acquired by transmitting and receiving the ultrasonic waves multiple times, the higher the wind speed.

Therefore, the wind speed can be estimated with a high accuracy.

In addition, the object detection device may further include a second acquisition unit configured to acquire speed information on a moving speed of the moving body, and the estimation unit may further estimate the wind speed based on the moving speed.

Therefore, the wind speed can be estimated with a higher accuracy.

In addition, the object detection device may further include a second generation unit configured to generate impossible information indicating that the detection target is not detectable by transmitting and receiving the ultrasonic waves when the wind speed exceeds an upper limit value.

Therefore, it is possible to reduce a possibility that a detection result with a low reliability is used for the control of the moving body or the like.

In addition, the object detection device may further include a detection unit configured to detect a change in a state of the road surface based on a change in the road surface reflection intensity, and the estimation unit may discard the road surface reflection intensity corresponding to the road surface for which the change is detected by the detection unit.

Therefore, it is possible to reduce a possibility that a variation in the road surface reflection intensity caused by the change in the state of the road surface and a variation in the road surface reflection intensity due to the influence of the wind are confused with each other, and it is possible to improve an estimation accuracy of the wind speed.

In addition, the detection unit may determine that the state of the road surface changes when a difference between an average value of a plurality of the road surface reflection intensities acquired at an initial stage in a road surface reflection intensity group including the plurality of road surface reflection intensities acquired by transmitting and receiving the ultrasonic waves multiple times in succession and an average value of a plurality of the road surface reflection intensities acquired at a final stage in the road surface reflection intensity group is equal to or greater than a threshold value.

Therefore, the change in the state of the road surface can be detected with a high accuracy.

A moving body control device according to an aspect of this disclosure includes: the object detection device described above; and a control device configured to perform a process for controlling the moving body based on the object information output from the object detection device.

According to the above configuration, the moving body can be controlled based on the object information generated by the object detection device.

Although the embodiment of this disclosure has been described, the embodiment described above and modifications thereof have been presented by way of example only, and are not intended to limit the scope of the inventions. The novel embodiment and the modifications thereof described above can be embodied in a variety of forms; furthermore, various omissions, substitutions, and changes can be made without departing from the gist of the inventions. The embodiment and modifications thereof described herein are included in the scope and gist of this disclosure, and are also included in the inventions described in the claims and their equivalents.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An object detection device that detects an object existing around a moving body moving on a road surface by transmitting and receiving ultrasonic waves, the object detection device comprising:
a first acquisition unit configured to acquire reflection intensity information indicating an intensity of a reflected wave from the object;
a first generation unit configured to generate object information indicating existence of a predetermined detection target when the reflected wave having an intensity exceeding a threshold value is received;
an estimation unit configured to estimate a wind speed based on a road surface reflection intensity, which is an intensity of a reflected wave from the road surface; and
a setting unit configured to change the threshold value according to the wind speed.

2. The object detection device according to claim 1, wherein
the setting unit increases the threshold value according to an increase in the wind speed.

3. The object detection device according to claim 1, wherein
the estimation unit estimates that the larger a degree of variation in a plurality of the road surface reflection intensities acquired by transmitting and receiving the ultrasonic waves multiple times, the higher the wind speed.

4. The object detection device according to claim 1, further comprising:
a second acquisition unit configured to acquire speed information on a moving speed of the moving body, wherein
the estimation unit further estimates the wind speed based on the moving speed.

5. The object detection device according to claim 1, further comprising:
a second generation unit configured to generate impossible information indicating that the detection target is not detectable by transmitting and receiving the ultrasonic waves when the wind speed exceeds an upper limit value.

6. The object detection device according to claim 1, further comprising:
a detection unit configured to detect a change in a state of the road surface based on a change in the road surface reflection intensity, wherein
the estimation unit discards the road surface reflection intensity corresponding to the road surface for which the change is detected by the detection unit.

7. The object detection device according to claim 6, wherein
the detection unit determines that the state of the road surface changes when a difference between an average value of a plurality of the road surface reflection intensities acquired at an initial stage in a road surface reflection intensity group including the plurality of road surface reflection intensities acquired by transmitting and receiving the ultrasonic waves multiple times in succession and an average value of a plurality of the road surface reflection intensities acquired at a final stage in the road surface reflection intensity group is equal to or greater than a threshold value.

8. A moving body control device comprising:
the object detection device according to claim 1; and
a control device configured to perform a process for controlling the moving body based on the object information output from the object detection device.
